(19) United States
(12) Patent Application Publication
(10) Pub. No.: US 2008/0108242 A1
(43) Pub. Date: May 8, 2008

(54) High frequency self-lock connector

(75) Inventors: Xiangwen Wu, Xi' an City (CN); Gangzhu Zhang, Xi' an City (CN); Qiuli Yang, Xi' an City (CN); Jingliang Zhang, Xi' an City (CN)

Correspondence Address: WELSH & KATZ, LTD, 120 S RIVERSIDE PLAZA, 22ND FLOOR, CHICAGO, IL, 60606, US

(73) Assignee: XI' AN FORSTARS & Co. LTD., Xi' an City (CN)

(21) Appl. No.: 11/891,342

(22) Filed: Aug. 10, 2007

(30) Foreign Application Priority Data
Nov. 2, 2006 (CN) 200610104844.6

(51) Int. Cl. H01R 4/26

(52) U.S. Cl. 439/345

(57) ABSTRACT

The present invention relates to a high frequency self-lock connector, comprising a plug and a socket (16), wherein the plug (17) further comprising a plug sleeve connected with the plug housing (11) via an elastic member (10); a first contact member (8) is disposed within the plug sleeve (6); the first contact member (8) is fixed with respect to the plug housing (11); the first contact member (8) clamps the socket housing (3); a second contact member (9) is fixed on the plug housing (11) and connected with the first contact member (8) via the plug housing (11); the second contact member (9) abuts on an inner step of the socket housing (3); and the plug inner conductor (5) is in tight contact with the plug inner conductor (1). The connector of the present invention has a high vibration resistance, stable phase, quick connection, small SWR and good stability and is convenient for use.

### FIELD OF THE INVENTION

The present invention relates to a RF coax connector for microwave transmission. Specifically, the present invention relates to a high frequency push-in type quick self-lock connector.

### BACKGROUND OF THE INVENTION

RF coax connectors serve to connect coax transmission lines, microstrip circuits and PCB circuits in microwave transmission circuits. Since RF coax connectors have the advantages that they have a wide working frequency band and provide a convenient connection and a high reliability, they are widely used in the field of aerospace and aviation systems, microwave communication engineering, and military and arms industry. RF coax connectors have a variety of connection means depending on applications, typically including threaded connection, bayonet connection, plug-in connection and push-in type self-lock connection. The threaded connection is characterized by high and good electrical property, but it has a slow connection speed and requires a sufficient surrounding space so that it is impossible to realize quick connection and high density arrangement. The plug-in and bayonet connections both have quick connection speed, but electrical property and vibration resistance thereof are too poor to be used in high demanding applications. The push-in type self-lock connection is characterized by quick connection and high reliability, but with conventional push-in type self-lock connectors, the connection interface configuration is complicated and tolerance accumulation of many dimensions renders a great variation in electrical length of the connector interface, and therefore, they have a high cost and can not be used in a system requiring good electrical property.

### SUMMARY OF THE INVENTION

To address one or more of the above problems, the present invention provides a novel high frequency push-in type quick self-lock connector, which has a good vibration resistance, quick connection, small VSWR (voltage standing wave ratio), and higher stability and is convenient for use. At the same time, the present invention provides a method for realizing a push-in type structure for coupling with a SMA type connector.

According to one aspect of the present invention, a high frequency self-lock connector is provided, comprising a plug and a socket, the plug having a plug housing and a plug inner conductor, the socket having a socket housing and a socket inner conductor; the plug may be inserted into the socket in an axial direction, wherein the plug further comprising a plug sleeve connected with the plug housing via an elastic member in such a way that the plug sleeve is capable of being displaced in the axial direction with respect to the plug housing; a first contact member is disposed within the plug sleeve, the first contact member is fixed with respect to the plug housing; a second contact member is fixed on the plug housing and cooperates with the first contact member to define a receiving space for receiving the socket housing; when the plug is inserted into the socket, the socket housing is received in the receiving space; the first contact member clamps the socket housing; an end face of the second contact member abuts on an inner step of the socket housing; and the plug inner conductor is in tight contact with the socket inner conductor.

According to one embodiment of the present invention, the first contact member is a ring-shaped elastic body with a slot. The ring-shaped elastic body is deformable in the radial direction. A projection is formed on the inner periphery of the first contact member. The two sides of the projection are slanted with different inclinations.

According to one embodiment of the present invention, a groove is formed on the outer periphery of the socket housing. The two sides of the groove are slanted. A sealing ring is fitted on the inner periphery of the socket housing. When the plug is inserted into the socket, the projection of the first contact member is caught by the groove of the socket housing.

According to one embodiment of the present invention, the side of the projection on the plug side is slanted with a larger inclination than the side of the projection on the socket side.

According to one embodiment of the present invention, the side of the groove on the plug side is slanted with a larger inclination than the side of the groove on the socket side.

According to one embodiment of the present invention, the first contact member is provided with a boss at one end and a supporting part at the other end in the axial direction on the outer periphery thereof. When the plug sleeve is disposed in a first position where the plug sleeve is close to the plug housing in the axial direction, the first contact member is fixed by the boss and the supporting part supported on the inner periphery of the plug sleeve; when the plug sleeve is disposed in a second position where the plug sleeve is distant from the plug housing in the axial direction, the boss is moved out of the plug sleeve and the first contact member is fixed only by the supporting part.

According to another aspect of the present invention, a high frequency self-lock connector is provided, comprising a plug and socket, the plug having a plug housing and a plug inner conductor, the socket having a socket housing and a socket inner conductor, the plug can be inserted into the socket in an axial direction, wherein the plug further comprising a plug sleeve.

According to an embodiment of the present invention, the socket used with the high frequency self-lock connector may be a SMA type RF coax connector socket, wherein a connection sleeve is threadedly fastened to the housing of the SMA type RF coax connector socket, the connection sleeve having a recess at the front end thereof, the plug sleeve being connected with the plug housing via an elastic member in such a way that the plug sleeve is capable of being displaced in the axial direction with respect to the plug housing; a first contact member is disposed within the plug sleeve, the first contact member is fixed with respect to the plug housing; a second contact member is fixed on the plug housing and cooperates with the first contact member to define a receiving space for receiving the socket housing and the connection sleeve; when the plug is inserted into the assembly consisting of the SMA type RF coax connector socket and the connection sleeve, the socket housing and the connection sleeve are received in the receiving space; the first contact member clamps the socket housing; the second contact member abuts on an inner step of the socket housing; and the plug inner conductor is in tight contact with the socket inner conductor.

According to an embodiment of the present invention, the first contact member is a ring-shaped elastic body. The ring-shaped elastic body is deformable in the radial direction. A projection is formed on the inside of the first contact member. The two sides of the projection are slanted with different inclinations.

According to one embodiment of the present invention, a groove is formed on the outer periphery of the connection sleeve. When the plug is inserted into the assembly, the projection of the first contact member is caught by the groove of the connection sleeve.

According to one embodiment of the present invention, the connection sleeve is a sleeve having ¼″-36UNS-2B threads; the two sides of the groove of the connection sleeve are slanted respectively with a predetermined inclination. An inner chamfer and an outer chamfer are formed respectively at the inner side and the outer side of the opening end of the connection sleeve.

According to one embodiment of the present invention, the second contact member is a cylindrical member fixed to or integrally formed with the first contact member.

In comparison with the prior arts, the present invention can achieve the following advantages and technical effects:

1. The connector of the present invention has a good mechanical property in that it has a quick and reliable connection, requires a small space and the cost thereof is low. Also, the connector of the present invention has a good electrical property and high vibration resistance and is adapted to be used under high frequency while obtaining stable signal.

2. The connector of the present invention is simple and convenient for use and can meet the requirement of the new generation high frequency connector.

### BRIEF DESCRIPTION OF THE DRAWINGS

The embodiments of the present invention will be described with reference to the accompanying drawings.

FIG. 1 is an exploded schematic view showing the structure of a connector according to an embodiment of the present invention, in which the plug and the socket are in a disassembled state;

FIG. 2 is a schematic view of the connector, in which the plug and the socket are in an assembled state;

FIG. 3 is a schematic view of the connector showing the process for pushing the plug into the socket;

FIG. 4 is a schematic view of the connector showing the process for withdrawing the plug from the socket;

FIG. 5 is a partially enlarged schematic view showing the engagement between the projection of the plug and the groove of the socket;

FIG. 6 is an exploded schematic view showing the plug and the SMA type RF coax connector socket in a disassembled state;

FIG. 7 is a schematic view showing the plug and the SMA type RF coax connector socket in an assembled state;

FIG. 8 is a schematic view showing the connection between the connection sleeve and the SMA type RF coax connector socket;

FIG. 9 is a schematic view showing the process for pushing the plug into the assembly consisting of the SMA type RF coax connector socket and the connection sleeve;

FIG. 10 is a schematic view showing the process for withdrawing the plug from the assembly consisting of the SMA type RF coax connector socket and the connection sleeve;

### THE REFERENCE NUMERALS IN THE FIGURES ARE LISTED AS BELOW

1 socket inner conductor

2 socket insulation support

3 socket housing

4 sealing ring

5 plug inner conductor

6 outer sleeve

7 plug insulation support

8 first contact member

9 second contact member

10 elastic body

11 plug housing

12 socket inner conductor

13 socket insulation support

14 socket housing

15 connection sleeve

16 socket

17 plug

18 SMA type RF coax connector socket

19 assembly

20 groove

21 projection

22 boss

23 supporting part

24 inner step

25 end face

26 outer chamfer

27 inner chamfer

28 recess

29 slot

30 mechanical and electrical reference face of SMA type RF coax connector socket

### DETAILED DESCRIPTION OF THE PREFERRED EMBODIMENTS

The present invention will be described in detail with reference to the embodiments. The examples thereof are shown in the figures. Throughout the drawings, the same reference numerals designate the same elements or parts. The embodiment is described in conjunction with the drawings in order to explain the present invention

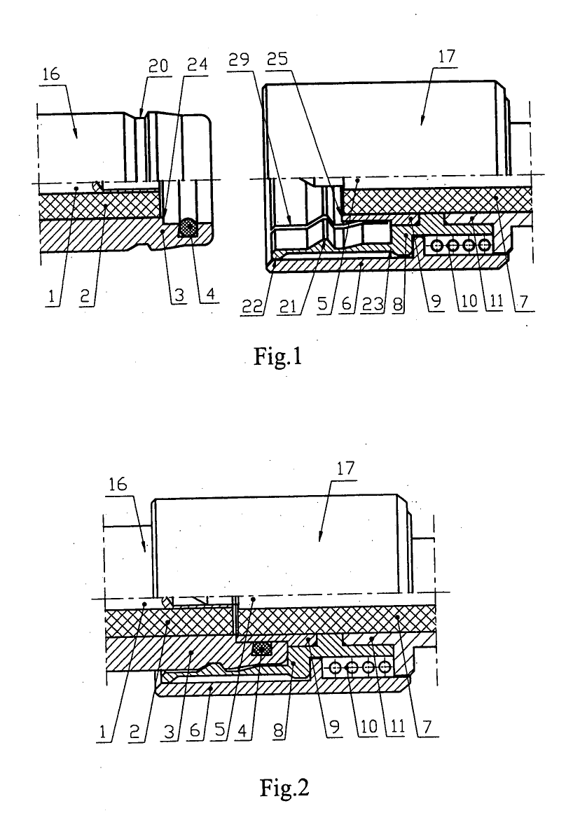

FIGS. 1-5 shows the first embodiment of the high frequency self-lock connector according to the present invention. As shown in FIGS. 1-5, the connector comprises a socket 16 and a plug 17. The plug 17 has a plug housing 11 and a plug inner conductor 5. The socket 16 has a socket housing 3 and a socket inner conductor 1. The plug 17 may be inserted into the socket 16 in an axial direction. The plug 17 further comprising a plug sleeve 6 connected with the plug housing 11 via an elastic member 10. A first contact member 8 is disposed within the plug sleeve 6. The plug sleeve 6 serves to protect the first contact member 8 and control the locking elastic force thereof. The first contact member 8 is fixed with respect to the plug housing 11. A second contact member 9 is fixed on the plug housing 11. The second contact member 9 has an end face 25 serving to control the mechanical and electrical reference face. The second contact member 9 may be a cylindrical member fixed to or integrally formed with the first contact member 8. The second contact member 9 and the first contact member 8 cooperate to define a receiving space for receiving the socket housing 3. When the plug 17 is inserted into the socket 16, the socket housing 3 is received in the receiving space of the plug 17, the first contact member 8 clamps the socket housing 3, the end face 25 of the second contact member 9 abuts on an inner step 24 of the socket housing 3, and the plug inner conductor 5 is in tight contact with the socket inner conductor 1.

The connector of the present invention includes a mechanical connection unit and an electrical connection unit. The two units are designed in connection with each other and the mechanical connection unit ensures the function of the electrical connection unit. The mechanical connection unit includes the socket housing 3, the plug housing 11, a sealing ring 4 (described later), the plug sleeve 6, the first contact member 8 and the second contact member 9, a connection sleeve 15 (described later), the elastic member 10 and a press-fit member behind it. The electrical connection unit includes a receptacle, a socket insulation supports 2 and 13, a plug insulation support 7, the socket housing 3, the plug housing 11, the socket inner conductors 1 and 12, the plug inner conductor 5, the first contact member 8 and the second contact member 9. The socket insulation supports 2 and 13 and the plug insulation support 7 are disposed between the first contact member 8, the second contact member 9 and the socket inner conductors 1 and 12, the plug inner conductor 5. The connector employs a spring-lock contact manner in the electrical connection interface. The relative position of the plug 17 and the socket 16 in a free state and the contact pressure after connection thereof are determined by the elastic member 10 and the plug sleeve 6. The socket 16 includes the socket inner conductor 1, the socket insulation support 2, the socket housing 3 and the sealing ring 4. The sealing ring 4 increases the sealing property of the connector. The mechanical connection unit of the plug 17 includes the plug sleeve 6. The first contact member 8 is surrounded by the sleeve 6. The elastic member 10 controls the force for moving the sleeve 6.

According to an embodiment of the present invention, the first contact member 8 made of elastic material is a ring-shaped elastic body with a slot 29 and capable of deforming in a radial direction. A projection 21 is formed on the inside of the first contact member 8. The two sides of the projection 21 are slanted with different inclinations, so that when the socket housing 3 is inserted, the insertion force is gentle and the lock is reliable. The engagement between the first contact member 8 and the inner wall of the plug housing 11 makes the stability and electrical property of the connector increase after the plug is inserted into the socket.

A groove 20 is formed on the outer periphery of the socket housing 3. The two sides of the groove 20 are slanted. The sealing ring 4 is fitted on the inner periphery of the socket housing 3. When the plug 17 is inserted into the socket 16, the projection 21 of the first contact member 8 is caught by the groove 20 of the socket housing 3.

Preferably, the side of the projection 21 on the plug side is slanted with a larger inclination than the side of the projection on the socket side, and the side of the groove 20 on the plug side is slanted with a larger inclination than the side of the groove on the socket side, so that the plug 17 can be smoothly inserted into the socket 16 during the insertion, and the socket and the plug are not easy to be detached from each other after insertion.

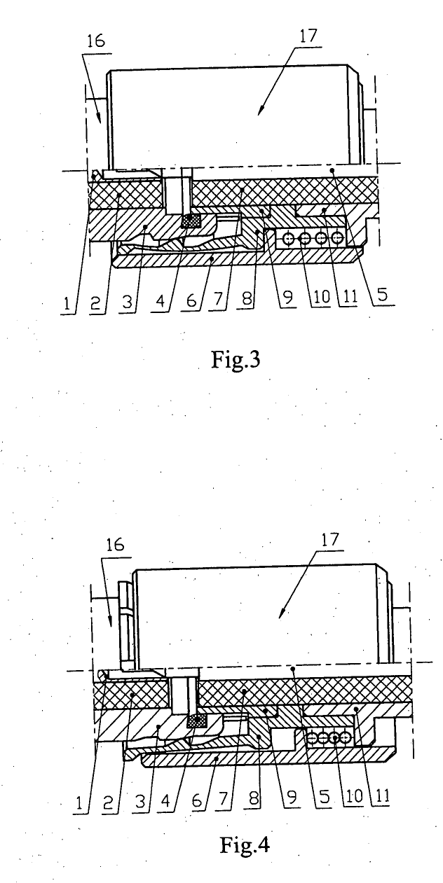

The elastic member 10 is provided between the plug housing 11 and the plug sleeve 6. The elastic member 10 can be elastically compressed in the axial direction under the effect of an external force and restore to its original axial length after the external force is withdrawn. Therefore, the plug sleeve 6 connected with the elastic member 10 can be displaced in the axial direction. The first contact member 8 is provided with a boss 22 at one end and a supporting part 23 at the other end in the axial direction on the outer periphery thereof. When the elastic member 10 is in a normal stretched state, the plug sleeve 6 is disposed in a first position where the plug sleeve 6 is close to the plug housing 11 in the axial direction. At this time, the first contact member 8 is fixed by the boss 22 and the supporting part 23 supported on the inner periphery of the plug sleeve 6, and the first elastic contact member 8 forms a shear strut beam structure as shown in FIG. 3; when the elastic member 10 is compressed in the axial direction, the plug sleeve 6 is moved accordingly to a second position where the plug sleeve 6 is distant from the plug housing 11 in the axial direction. At this time, the boss 22 is moved out of the plug sleeve 6, and the first contact member 8 is fixed only by the supporting part 23.

As shown in FIG. 2, when the connector of the present invention is in a connection state, the projection 21 of the first elastic contact member 8 is caught by the groove 20 of the socket housing 3. The end face 25 of the second contact member 9 abuts on the inner step 24 of the socket housing 3. The plug sleeve 6 maintains in a normal state under the action of the elastic force of the elastic member 10. When the external force acting on the plug sleeve 6 is less than the elastic force of the elastic member 10, the thickness of the wall of the first elastic contact member 8 and the inclination of the right side of the projection 21 are controlled such that the vector sum of the elastic force of the first elastic contact member 8 and the friction force acting on the socket housing 3 is greater than a predetermined external force acting on the socket housing 3 for separating the socket housing 3 from the first elastic contact member 8. As a result, the plug 17 and the socket 16 are self-locked and will not detached. At this time, the socket inner conductor 1 and the plug inner conductor 2 tightly contact with each other, and the whole connector are in a lock state.

As shown in FIG. 3, the socket 16 is pushing into the plug 17. The front end of the first elastic contact member 8 is locked by the plug sleeve 6 and can not move radially. Therefore, the elastic first contact member 8 forms a shear strut beam supported at two ends thereof. The wall thickness of the first elastic contact member 8 and the inclination of the left side of the projection 21 are controlled such that a predetermined force is necessary when the plug is inserted into the socket and the connection is reliable.

As shown in FIG. 4, the socket 16 is being extracted from the plug 17. The sleeve 6 presses against the elastic member 10 under external force. The sleeve 6 is retracted back and moves across the boss 22 of the first contact member 8. At this time, the first elastic contact member 8 forms a cantilever beam structure. When the external force acting on the socket housing 3 for detaching from the first elastic contact member 8 becomes greater than a certain force, the plug 17 and the socket 16 are separated from each other. At this time, the socket inner conductor and the plug inner conductor are separated from each other, and the connector is in an unlock state.

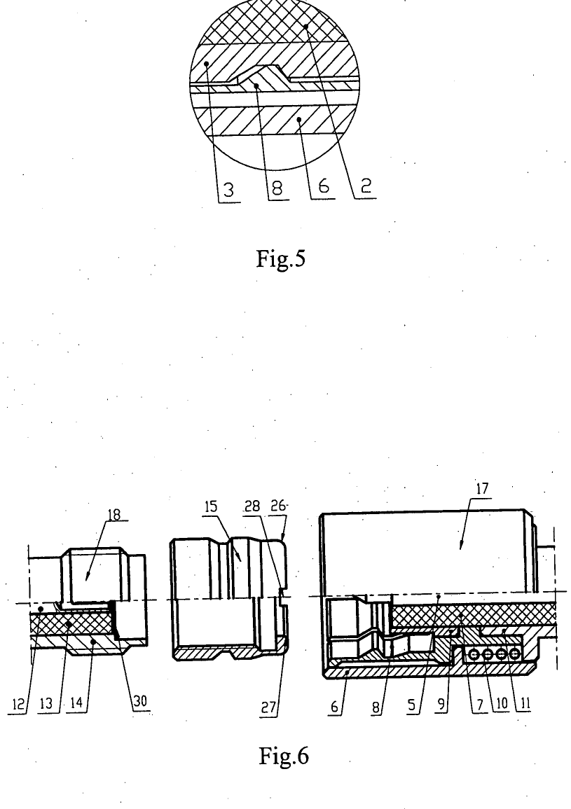

As shown in FIG. 5, the first elastic contact member 8 is in a normal state with the projection 21 thereof being caught by the groove 20 of the socket housing 3 so that the socket housing 3 is subject to a certain positive pressure by the elasticity of the first contact member and a reliable contact between the socket and the plug is ensured.

FIGS. 6-10 show a second embodiment of the present invention. Except that the socket is a SMA type RF coax connector socket 18 and that a connection sleeve 15 is provided, the self-lock connector according to the second embodiment of the present invention has the same structure as that of the first embodiment. Therefore, the similar structures are not described in the second embodiment. The socket according to the second embodiment is a SMA type RF coax connector socket. A connection sleeve 15 is threadedly connected on the outer periphery of the SMA type RF coax connector socket 14. Unlike the first embodiment, when the plug 17 is inserted into the assembly 19 consisting of the socket 18 and the connection sleeve 15, the socket housing 14 and the connection sleeve 15 both are received in the receiving space of the plug, and the first contact member 8 clamps the connection sleeve 15 instead of the socket housing 3.

As shown in FIG. 6, the connection sleeve 15 is in the form of a sleeve and formed with a groove 20 on the outer periphery thereof and a recess 28 at the front end thereof. The inside of the connection sleeve 15 is formed with ¼″-36UNS-2B threads, which are capable of engaging with the threads on the housing 14 of the SMA type RF coax connector socket with a receptacle by a tool. The SMA type RF coax connector socket 18 connected with the connection sleeve 15 can be inserted into the first elastic contact member 8. The projection 21 of the first elastic contact member 8 may be caught by the groove 20 on the outer periphery of the connection sleeve 15 so as to lock the connection sleeve 15 and ensure that the second contact member 9 abuts on the mechanical and electrical reference face of the housing 14 of the SMA type RF coax connector socket. The second contact member 9 may be a cylindrical member fixed in or integrally formed with the first contact member 8 with an end face thereof serving as a mechanical and electrical reference face.

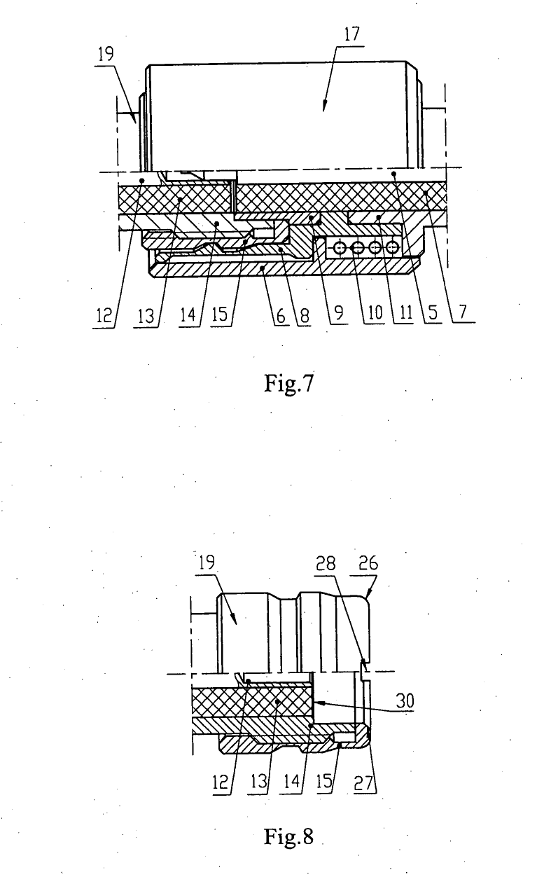

As shown in FIG. 7, when the connector according to the present embodiment is in a connection state, the projection 21 of the first elastic contact member 8 is caught by the groove 20 of the connection sleeve 15. The end face of the second contact member 9 abuts on mechanical and electrical reference face 30 inside the housing 14 of the SMA type RF coax connector socket.

The connection sleeve 15 is subject to a certain positive pressure force by the elasticity of the first contact member 8 so as to ensure that the plug 17 and the socket 16 are reliably contacted with each other and the plug 17 and the socket 16 are self-locked and will not be detached. At this time, the second contact member 9 abuts on the mechanical and electrical reference face 30 of the housing 14 of the SMA type RF coax connector socket, and the whole connector is in a lock state.

As shown in FIG. 8, the connection sleeve 15 is formed with a groove 20 on the outer periphery thereof and a “-” shaped recess 28 at the front end thereof. The inside of the connection sleeve 15 is formed with ¼″-

36UNS-

2B threads, which are capable of engaging with the threads on the housing 14 of the SMA type RF coax connector socket by a tool. The SMA type RF coax connector socket 18 connected with the connection sleeve 15 can be inserted into the first elastic contact member 8 as an assembly 19. The two sides of the groove 20 are slanted with a certain inclination to control the magnitude of the force for extracting the first contact member 8. An inner chamfer 27 and an outer chamfer 26 are formed respectively at the inner side and the outer side of the opening end of the connection sleeve 15. The outer chamfer 26 serves to guide the first contact member 8 during the insertion thereof. The inner chamfer 27 serves to guide the second contact member 9.

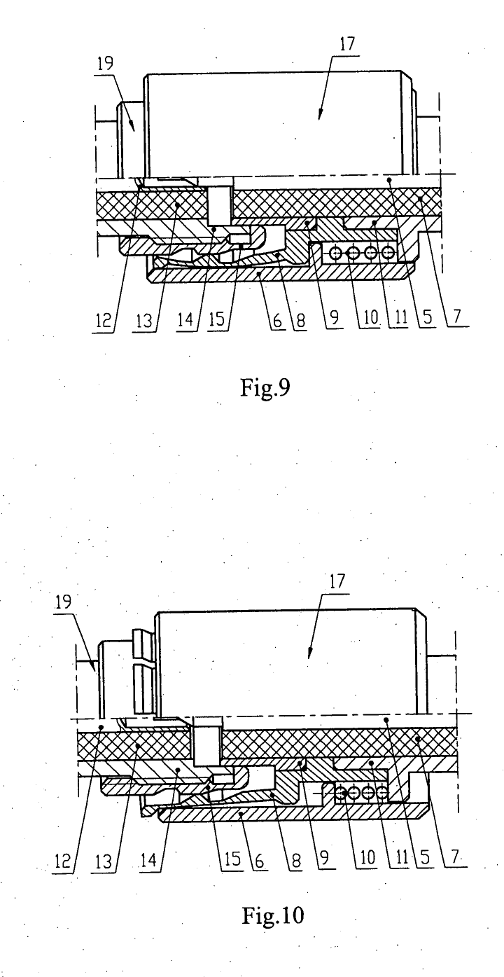

As shown in FIG. 9, when the pushing force exerted on the SMA type RF coax connector socket 18 with the connection sleeve 15 is greater than the sum force of the elastic force of the elastic structure of the first contact member 8 and the friction force, the assembly 19 is pushed into the plug 17. The connector is in a lock state.

As shown in FIG. 10, when the pulling force exerted on the SMA type RF coax connector socket 18 with the connection sleeve 15 is greater than the sum force of the elastic force of the elastic structure of the first contact member 8 and the friction force, the assembly 19 is drawn out of the plug 17. That is, the plug 17 is detached from the assembly 19. The connector is in an unlock state.

Preferably, the two sides of the groove 20 on the outer periphery of the connection sleeve 15 are inclined with different inclinations. The steeper side of the groove 20 serves to engage the inclined inner side of the first contact member 8 to increase the reliability of connection, and the less steeper side of the groove 20 ensures that the first contact member fully contacts the socket housing. The recess 28 ensures that the connection sleeve 15 and the housing 14 of the SMA type Rf coax connector socket can be completely screwed and sufficiently attached together.

The high frequency push-in type quick self-lock connector of the present invention is adapted to be used with a variety of semi-rigid and semi-flexible soft cable. The connector of the present invention may also be a curved or microstrip connector, various adaptors and the like.

Although the embodiments of the present invention have been described and illustrated above, it will be appreciated by those skilled in the art that the embodiments can be further modified and changed in various ways without departing from the scope of the claims.

What is claimed is:

1. A high frequency self-lock connector, comprising:
a socket (16) and a plug (17), the plug (17) having a plug housing (11) and a plug inner conductor (5), the socket (16) having a socket housing (3) and a socket inner conductor (1); the plug (17) can be inserted into the socket (16) in an axial direction, wherein
the plug (17) further comprising a plug sleeve (6) connected with the plug housing (11) via an elastic member (10) in such a way that the plug sleeve (6) is capable of being displaced in the axial direction with respect to the plug housing (11); a first contact member (8) is disposed within the plug sleeve (6); the first contact member (8) is fixed with respect to the plug housing (11); a second contact member (9) is fixed on the plug housing (11) and cooperates with the first contact member (8) to define a receiving space for receiving the socket housing (3); and wherein
when the plug (17) is inserted into the socket (16), the socket housing (3) is received in the receiving space; the first contact member (8) clamps the socket housing (3); the second contact member (9) abuts on an inner step (24) of the socket housing (3); and the plug inner conductor (5) is in tight contact with the socket inner conductor (1).

2. The high frequency self-lock connector according to claim 1, wherein
the first contact member (8) is a ring-shaped elastic body with a slot (29), and the ring-shaped elastic body is deformable in the radial direction; and
a projection (21) is formed on the inner periphery of the first contact member (8), and the two sides of the projection (21) are slanted with different inclinations.

3. The high frequency self-lock connector according to claim 2, wherein a groove (20) is formed on the outer periphery of the socket housing (3), and the two sides of the groove (20) are slanted;
a sealing ring (4) is fitted on the inner periphery of the socket housing (3); and
when the plug (17) is inserted into the socket (16), the projection (21) of the first contact member (8) is caught by the groove (20) of the socket housing (3).

4. The high frequency self-lock connector according to claim 2, wherein the side of the projection (21) on the plug side is slanted with a larger inclination than the side of the projection (21) on the socket side.

5. The high frequency self-lock connector according to claim 2, wherein the side of the groove (20) on the plug side is slanted with a larger inclination than the side of the groove (20) on the socket side.

6. The high frequency self-lock connector according to claim 2, wherein the first contact member (8) is provided with a boss (22) at one end and a supporting part (23) at the other end in the axial direction on the outer periphery thereof; when the plug sleeve (6) is disposed in a first position where the plug sleeve (6) is close to the plug housing (11) in the axial direction, the first contact member (8) is fixed by the boss (22) and the supporting part (23) supported on the inner periphery of the plug sleeve (6); when the plug sleeve (6) is disposed in a second position where the plug sleeve (6) is distant from the plug housing (11) in the axial direction, the boss (22) is moved out of the plug sleeve (6) and the first contact member (8) is fixed only by the supporting part (23).

7. A high frequency self-lock connector, comprising:
a socket (16) and a plug (17), the plug (17) having a plug housing (11) and a plug inner conductor (5), the socket (16) having a socket housing (3) and a plug inner conductor (1), the plug (17) can be inserted into the socket (16) in the axial direction, wherein
the plug (17) further comprises a plug sleeve (6); the socket is a SMA type RF coax connector socket (18); a connection sleeve (15) is threadedly fastened to the housing (14) of the SMA type RF coax connector socket (18), the connection sleeve (15) having a recess (28) at the front end thereof; the plug sleeve (6) being connected with the plug housing (11) via an elastic member (10) in such a way that the plug sleeve (6) is capable of being displaced in the axial direction with respect to the plug housing (11); a first contact member (8) is disposed within the plug sleeve (6); the first contact member (8) is fixed with respect to the plug housing (11); a second contact member (9) is fixed on the plug housing (11) and cooperates with the first contact member (8) to define a receiving space for receiving the socket housing (14) and the connection sleeve (15); and wherein
when the plug (17) is inserted into the socket (18), the socket housing (14) and the connection sleeve (15) are received in the receiving space; the first contact member (8) clamps the connection sleeve (15); the second contact member (9) abuts on a mechanical and electrical reference face (30) inside the socket housing (14); and the socket inner conductor (1) is in tight contact with the plug inner conductor (5).

8. The high frequency self-lock connector according to claim 7, wherein
the first contact member (8) is a ring-shaped elastic body, and the ring-shaped elastic body is deformable in the radial direction; and
a projection (21) is formed on the inside of the first contact member (8), and the two sides of the projection (21) are slanted with different inclinations.

9. The high frequency self-lock connector according to claim 8, wherein
a groove (20) is formed on the outer periphery of the connection sleeve (15); and
when the plug (17) is inserted into the socket (18), the projection (21) of the first contact member (8) is caught by the groove (20) of the connection sleeve (15).

10. The high frequency self-lock connector according to claim 7, wherein
the connection sleeve (15) is a sleeve having ¼″-36UNS-2B threads;
the two sides of the groove (20) of the connection sleeve (15) are slanted respectively with a predetermined inclination; and
an inner chamfer (26) and an outer chamfer (27) are formed respectively at the inner side and the outer side of the opening end of the connection sleeve (15).

11. The high frequency self-lock connector according to claim 7, wherein
the second contact member (9) is a cylindrical member fixed to or integrally formed with the first contact member (8).
